(19) United States
(12) Patent Application Publication
(10) Pub. No.: US 2008/0216064 A1
(43) Pub. Date: Sep. 4, 2008

(54) Method, Architecture and Software of Meta-Operating System, Operating Systems and Applications For Parallel Computing Platforms

(76) Inventor: William Braswell, Cedar Park, TX (US)

Correspondence Address: MATTHEW E. BURR, 620 CONGRESS AVENUE, STE 320, AUSTIN, TX, 78701, US

(21) Appl. No.: 12/099,772

(22) Filed: Apr. 8, 2008

Related U.S. Application Data
(63) Continuation-in-part of application No. PCT/US05/34921, filed on Sep. 29, 2005.

(51) Int. Cl. G06F 9/45

(52) U.S. Cl. 717/149

(57) ABSTRACT

A method, architecture, and tangible medium storing computer readable software provides a meta-operating system, native operating systems and native applications which have been designed to operate upon one or more parallel computing platforms. The meta-operating system provides for an abstracted model of a standard operating system designed to manage one or more underlying standard operating systems, and may comprise components such as computer programming languages, development environments, user interfaces, hardware platform interfaces, operating system interfaces, parallelization platform interfaces, non-native application support, or others.

### CROSS REFERENCE TO RELATED APPLICATIONS

This application is a continuation-in-part of, and claims priority from, application serial number PCT/US05/34921 filed Oct. 1, 2005, by the same inventor and entitled “Parallel Computing Operating System and Meta-Operating System,” the disclosure of which is incorporated herein by reference in its entirety.

### TECHNICAL FIELD

The present disclosure generally relates to parallel computing, and specifically concerns a method, architecture, and tangible medium storing computer readable software that facilitates execution of software upon parallel computing platforms.

### BACKGROUND

Parallel Computing

Since its inception in the 1940's, the computing industry has been widely known for the most rapid rate of change among all industries. Moore's Law dictates that every 18 to 24 months, computers double in speed via transistor density. Until now, this has resulted in constantly increased serial processor clock rates, now approximately 2.5-3.5 GHz for standard CPU's. However, because of the physical limitations of producing smaller and smaller silicon microchips, the increase of processor clock rates is now slowing. For computer manufacturers to continue producing faster systems according to Moore's Law, they must now finally move away from serial processing and fully embrace parallel processing. All microchip manufacturers have now publicly announced their move to produce parallel multi-core processors, including Intel®, AMD®, Sun®, IBM®, etc. The first significant “dual-core” processors were put out by Intel® and AMD® by Q2 2005, and as of Q4 2006 almost all PCs, servers, and HPCs were being offered with multi-core processors.

By Q2 2007, Intel® and AMD® were offering “quad-core” processors as their top-of-the-line products. By Q4 2007, Sun Microsystems® began offering 8-core processors. Intel has announced that by 2009 they will be offering 80-core processors in the PC market. Multi-core processing will be one of the primary trends in computing for many years to come.

When considering the erupting multi-core processor market, it is important to understand that there are currently three competing types of multi-core processor: the standard multi-core microchips built by Intel®, AMD®, and Sun®; the Cell® Broadband Engine microchips from IBM® and Sony®; and the graphical processing unit (GPU) chips produced by video card manufacturers. Currently, only Sony's PlayStation 3® video game console utilizes the cell processors, while hundreds of types of PCs, servers, and HPCs are now shipping with standard multi-core chips and GPUs. The primary reason for the lack of software support for the cell microchips and GPUs lies in their incompatibility with standard software applications, as well as the especially difficult and non-standard development environment used to program Cell- and GPU-compatible applications. On the other hand, standard multi-core processors are compatible with pre-existing serial software applications, and popular tools are used to program their new parallel software applications.

Web 2.0

Since its creation in the early 1990's, the World-Wide Web (or just “the Web”) has exemplified the most quickly changing aspect of all computing technology—raw information and the utilization thereof. The original Web (“1.0”) was primarily used for the static display of information. The most interactive websites would only allow you to input information through simple forms and menus. There was a significant difference in the level of functionality between full desktop applications and these simple interactive websites. In the last few years, this has all changed.

The most important aspect of the Web 2.0 is the global move to the Web as a “richly interactive” platform for all aspects of everyday life, including commerce, education, socialization, entertainment, and employment. Most previous software applications are now available in a Web-based format, and many new applications are being developed to take special advantage of advanced network functionality. The superior functionality of desktop-based over Web-based applications is rapidly shrinking, and will soon be non-existent. Some computer users will continue to prefer running critical applications locally rather than over the Web, but the majority of software will soon be delivered via Web 2.0. Advocates of Web 2.0 also point out the significant benefits that Web-based applications require no local installation and can be continuously upgraded by the constant feedback of Web 2.0 users.

There is no single technology wholly responsible for the upgrade from Web 1.0 to Web 2.0. Popularly accepted Web 2.0 technologies include “software as a service” (SAAS), “asynchronous Javascript and XML” (AJAX), wikis, blogs, mashups, webcasts, folksonomies, and social software networks. Each of these Web 2.0 technologies is an entire market sub-segment with currently unknown yet incredibly high value, as shown by Google's Q4 2006 acquisition of webcasting site YouTube® for $1.65 B. However, potentially the most significant and far-reaching of these is SAAS, the term given to the migration from desktop-based to Web-based applications. This is evidenced by ®Microsoft's Q4 2006 upgrade from the old desktop-based Office suite to the new Web-based “Office Live” in response to the release of the similar SAAS office suite “Google Docs®”. Microsoft has even announced an entire “Windows Live®” brand of SAAS products to enhance its Web 2.0 image.

Also becoming popular are the notions of “Web 2.5” and “Web 3.0”, meant to signify the continuing evolution of the Web experience over the years to come. The Web 2.5 is known as the “always-on Web”, referring to the pervasiveness of portable, wireless Web access devices. The popular existence of Web 2.5 will continue to increase over the next 2 to 3 years with the spread of wireless laptops, hand-held computers, and Web-ready cell phones. The Web 3.0 is the “next-next-generation” of Internet computing, and is characterized by the reduction of the Web to a global database system, creation of a logical “semantic Web”, and the inclusion of 3-D virtual reality technologies. Because many websites have yet to upgrade to even Web 2.0 technologies, it is unlikely that the Web 3.0 will become a reality for the next 5 to 10 years.

Personal Computer Trends

The three primary trends in personal computing are currently multi-core processors, Web 2.0, and portability. These three trends are combining to provide the average computer user with a far more powerful and complex set of tools than has previously existed.

Almost all major PC manufacturers are now shipping systems with multi-core processors installed. This means normal PCs now have the ability to run parallel applications, where before this was only possible on expensive “specialty” PCs with more than one processor. However, existing PC software is written for serial hardware, and is only capable of utilizing a single processor core, even if a new PC has four cores available (“quad-core” PCs). This means the only way, for the average PC user to actually utilize more than one of their multiple processor cores is the old practice of “multi-tasking”, where more than one independent serial application is run simultaneously This is not “true” parallelization, because the applications themselves are not parallel—it is only by executing multiple serial applications that the multi-core processor is being utilized. Even with multi-tasking, a user must be constantly switching between applications to cause each to require enough computational power for the multi-core processor to be exploited. Thus, while many PCs now include multi-core processors, they are greatly under-utilized in most situations. This under-utilization will only increase as the number of processing cores increases and the need for more cores does not. There are very few parallel applications written for PCs, and they are mostly video games.

The emergence of Web 2.0 technologies has also had a profound impact on personal computing. While the increased power of multi-core processors allows PCs to do far more than previously possible, the actual percentage of work done by the local PC itself is decreasing in favor of Web-based functionality. This means PC users are (somewhat paradoxically) demanding more from their new PCs in relation to their old PCs, while simultaneously demanding less of the new machines in relation to their new Web 2.0 applications. Of course, there will always be PC users who wholly or partially resist the transition from desktop-based to Web-based applications, primarily due to a lack of willingness to completely entrust important data to the care of a remote 3rd party. This means the Web 2.0 may become wildly popular, but it will never completely replace good old-fashioned local PC applications.

Portable computing is also becoming quite popular among PC users, and is the primary component of the Web 2.5. All new laptops now ship with wireless Internet connectivity, and many home, office, and public networks now offer wireless access “hot spots”. Advanced cell phone/computer hybrids such as the BlackBerry have enabled e-mail on-the-go. Many new standard cell phones now include miniature Web browsers that communicate directly over the cellular network. So-called “tablet” computers are also beginning to gain greater market share. All of these portable computing platforms are capable of some form of Web access, which is slowly allowing advanced Web 2.0 functionality to make its way into the mobile market.

Server Trends

Multi-core processors and the Web 2.0 have also affected the server market, in addition to the new method of “server virtualization”. The demands placed upon current servers by corporate and home PC users are tremendously greater than it has been in the past. These three new technologies have both eased and complicated the job of today's server systems.

Unlike current PCs, servers are ideal for use with multi-core processors. This is because sellers are generally utilized by multiple individuals simultaneously, which creates a naturally intense multi-tasking environment as each client's request must be independently handled by, the appropriate server software systems. As with PCs, server multi-tasking does not necessarily count as “true” parallelism, because the server's software need not be parallel itself. However, while a PC must have its single user quickly and constantly interacting with multiple applications to leverage the power of a multi-core processor, a server with many simultaneous users will naturally require more than one processing core to provide each client with a rapid response. Because of this, almost 100% of all new servers are shipping with multi-core processors installed.

The emergence of Web 2.0 technologies has put an incredible strain on both the performance and functionality of Internet servers. Originally, Web surfers accepted slow and simple servers, with the bare transfer of information being the primary objective. With Web 2.0, users now expect not only incredibly high data throughput, but also significantly increased website functionality. For example, webcasting sites like YouTube will soon exceed the total global Internet bandwidth, requiring thousands of new servers and networks to support mass online video distribution. Also, servers running SAAS such as Google Docs® or Microsoft Office Live® must provide clients with far more functionality than a standard static website, including full interactivity and richly dynamic user interfaces.

A new trend in server computing is “virtualization”, used to create software-based “virtual servers” that perform the same functions as real hardware servers, but can be modified and restarted without actually rebooting the underlying server hardware. This is important because it allows a single normal operating system to run on the servers' hardware, while multiple virtual servers can run any other operating systems within the normal operating system software environment. Virtualization is especially useful for testing and running less stable operating systems and software (like Windows® or Macintosh®) within a controlled virtual server environment on top of some other more stable operating system (like Linux or BSD). If any of the virtualized unstable operating systems encounter an error and crash, its virtual server can be immediately restarted without affecting any other virtual servers or the stable underlying operating system. Also, some virtualization software supports virtual server fail-over, allowing any client requests being sent to a recently crashed virtual server to be re-routed to a duplicate virtual server providing the same Internet services. Popular virtualization software products include VMware™, Xen™, Virtual Iron™, and Parallels Desktop™.

High-Performance Computing Trends

Multi-core processors have also heavily impacted the world of high-performance computing. This technology will continue to drastically increase the computational abilities of HPCs over the next few years.

Like current servers, high-performance computers are ideally suited for immediate use of multi-core processors. All new HPCs are shipping with multi-core processors factory installed. However, unlike servers this is not due to client request multi-tasking, but instead to “true” parallelization within individual applications themselves. (This is currently achieved by extremely expensive manual parallelization methods, and parallel applications are often restricted to executing only upon the specific HPC model for which they are developed.) High-performance computing has always included parallel software development, so there currently exist many HPC applications already compatible with standard multi-core processor architectures. Because of this pre-existing cache of compatible parallel applications, multi-core processors have gained immediate and full acceptance within the HPC community. In fact, there are already a few small companies like ClearSpeed™ and Azul Systems™ offering specialty, non-standard HPC acceleration boards with multi-core chips exceeding the number of cores offered by processor giants Intel® and AMD®.

### SUMMARY

The present disclosure describes exemplary embodiments of a method, architecture, and tangible medium storing computer readable software that provides for a meta-operating system, native operating systems and native applications which have been designed to operate upon one or more parallel computing platforms.

In general, disclosed is a method, architecture, and tangible medium storing computer readable software that provides for a meta-operating system, native operating systems and native applications which have been designed to operate upon one or more parallel computing platforms. The meta-operating system provides for an abstracted model of a standard operating system designed to manage one or more underlying standard operating systems, and may comprise components such as computer programming languages, development environments, user interfaces, hardware platform interfaces, operating system interfaces, parallelization platform interfaces, non-native application support, or others. The programming languages provide for automated parallelization of native applications implemented for the meta-operating system. The development environments provide for assisting software developers in creating software for the meta-operating system. The user interfaces provide for assisting users in controlling the meta-operating system. The hardware platform interfaces provide for executing the meta-operating system upon specific computing hardware platforms. The operating system interfaces provide for executing the meta-operating system upon operating systems. The parallelization platform interfaces provide for executing the meta-operating system upon parallelization platforms. The non-native application support provides for executing non-native applications upon the meta-operating system. The native operating systems provides for in operating system installed with the meta-operating system software utilizing one or more operating system interfaces. The native applications provide for data structures and algorithms developed using one or more of the programming languages of the meta-operating system.

Meta-operating systems effectively allow owners of multi-core PCs to fully utilize the parallel power of their multi-core processors. Meta-operating systems offer local, desktop-based functionality via server software, and remote, Web-based SAAS functionality via the client software as accessed from a standard Web browser. Although meta-operating systems are designed for compatibility with mobile devices, it is anticipated that due to a lack of processing power, it will be necessary for these devices to initially utilize meta-operating systems features over the Web. Several years from now, portable devices will themselves be fast enough to run their own meta-operating systems servers.

Meta-operating systems allow for the native development and execution of automatically parallelized applications. Server hardware will generally run the meta-operating system server software and provide clients with meta-operating system applications via the Web 2.0 SAAS model. Server hardware running the meta-operating system server software has built-in Web 2.0 SAAS capabilities, and may sense multiple simultaneous clients with remote access lo parallelized meta-operating system applications. Meta-operating systems may be natively installed inside a virtual machine running a compatible operating system.

Meta-operating systems are designed to support HPC systems running on both standard multi-core processors and non-standard multi-core architectures.

Meta-operating system users are divided into three primary categories: groups employing software developers or scientists; video game enthusiasts; and the general public. The groups employing software developers and scientists include corporations, academic institutions, and other organizations. The software developers and scientists will be the first meta-operating system users. When meta-operating system video games have been developed, gamers will begin migrating to utilizing meta-operating system software on their gaming machines. Ultimately, enough meta-operating system applications and games will be developed for computer-using members of the general public to begin upgrading to meta-operating system software on their PCs.

Numerous other advantages and features will become readily apparent from the following detailed description, from the claims and from the accompanying drawings.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of an exemplar embodiment of a meta-operating system of the present disclosure.

FIG. 2 is a diagrammatic illustration of an exemplary embodiment of the computer programming languages of the present disclosure.

FIG. 3 is a diagrammatic illustration of an exemplary embodiment of the development environments and interface components of the present disclosure.

### DETAILED DESCRIPTION

The following definitions may be useful to understanding the present disclosure:

“Abstraction” is a process by which data or a data type is converted from a specific form to a more generic form. For example, a specific “integer” data type of the programming language Perl may be converted to a corresponding generic “integer” data type of a translational programming language via the process of abstraction. Contrast with instraction.

“Abstraction/Instraction” is a process by which a translational programming language translates source code from an origin programming language to a destination programming language. For example, source code of the programming language Perl may be translated to equivalent source code of the programming language C++ via the process of abstraction/instraction.

“Advanced Micro Devices, Inc.” or “AMD” is a leading microprocessor development and production corporation.

“Agent” is an active power or cause with the power to produce an effect.

“Algorithm” is a collection of operations providing a solution to some problem.

“AMD Multi-Core®” is a class of multi-core processors produced by AMD®.

“Apple® Inc.” is a leading operating system and hardware system development and production corporation.

“Apple Macintosh®” is a class of operating systems produced by Apple® Inc. Some Macintosh® operating systems are members of the *NIX class of operating systems, specifically Macintosh® OSX which is based BSD.

“Application Software” or “Application” is a software product designed to be primarily utilized in the foreground or by a human user. Contrast with system software.

“Architecture” is a component product of the RSADCM software engineering process, comprising a formalized description of the overall organization of the software product under development.

“Architecting” is a component process of the RSADCM software engineering process, comprising the creation of a software architecture product based on the software specifications product.

“Automatic Parallelization” is a process by which software is made to execute concurrently upon a parallel computing platform, requiring little or no parallel detail specification by the software developer. This process should result in an ease of parallel software development. Contrast with manual parallelization.

“Berkeley Software Distribution” or “BSD” is a class of operating systems originally produced by members of the University of California at Berkeley. All BSD operating systems are members of the *NIX class of operating systems.

“Boolean” is a basic data type evaluated to a value of either true or false. Often a value of true is represented by a numeric value of 1 or more, or a string of length greater than one. Often a value of false is represented by a numeric value of 0 or less, or a string of length 0 or undefined.

“C” is an imperative programming language standard designed for standard serial computing platforms.

“C++” is an object-oriented programming language standard designed for standard serial computing platforms.

“Cell Broadband Engine Architecture”, “Cell/BE” or “Cell” is a class of multi-core processors jointly developed by Sony Computer Entertainment, Toshiba, and IBM.

“Celoxica Handel-C” is an imperative programming language designed for reconfigurable computing platforms, and produced by the Celoxica corporation.

“Class/Package/Module/Library” or “CPML” is a unit of organization in an object-oriented programming language. Within the object-oriented context, the terms class, package, module, and library are equivalent and thus combined into a single term.

“Clean Singleton Brackets” or “CSB” is a meta-argument of a functional programming language, representing a boolean value used to determine whether or not to remove an extraneous pair of enclosing brackets around a singleton (non-SMALVS) data type.

“Client” is a software product acting as a single recipient of data provided by a server software product. Contrast with a server.

“Client/Server” is a software execution architecture comprised of the interaction between one or more client software products and one or more server software products. This software execution architecture may provide both local and remote software functionality. This software execution architecture may be utilized to provide the SAAS software execution architecture.

“Cluster Computer” or “Cluster” is a hardware computing platform, comprising a parallel system of multiple loosely-coupled computer systems located in a single physical area.

“Coding” is a component process of the RSADCM software engineering process, comprising the creation of a software source code product based on the software design product.

“Command Line” is a user interface comprising primarily text-based functionality.

“Computational Kernel” is one or more algorithms or algorithm portions responsible for a majority of execution time of a specific software product.

“Computational Kernel Porting” is a process by which a software product's computational kernel is ported from an origin hardware or software system to a destination hardware or software system.

“Computer” is a combination of one or more pieces of computer hardware or software capable of computing the solution to one or more logical or mathematical problems.

“Computer/Interface/Environment/Agent/QFlux” or “CIEAQ” is a logical hierarchy representing the relationship between humans, computers, and reality. In general, a computer provides an interface between an environment and an agent according to the laws and organization of quantum fluctuation.

“Configuration” is a one or more values used to determine the behavior of a hardware or software system.

“Constant” is a data object comprising a value that will never change. Contrast with a variable data object.

“Context Switching” is a parallelization platform comprising a process of switching the execution context of concurrent processing elements to load said elements with new instructions or data.

“Cray XT5™” is a hardware platform produced by Cray Inc., optionally comprising one or more FPGA reconfigurable microprocessors.

“Cross-Linking” is a process by which a software product developed in a primary programming language is linked to one or more software products developed in one or more secondary programming languages.

“Data” is a component of the DIKW logical hierarchy, comprising raw numbers, letters, or other representative symbols.

“Data/Information/Knowledge/Wisdom” or “DIKW” is a logical hierarchy used to classify symbolic representations and the use of said symbolic representations.

“Data Object” is an individual piece of data of a specific data type, optionally comprising one or more component data objects.

“Data Structure” is a collection of data objects organized according to some logical hierarchy.

“Data Type” is a primary classification of a data object used to determine appropriate utilization of said data object. For example, a data object may have a data type of integer, real number, character, string, SMALVS, or other user-defined data type.

“Design” is a component product of the RSADCM software engineering process, comprising a formalized description of specific data and functionality of the software product under development. Various forms of flow chart and diagram are often used during the creation of a software design.

“Designing” is a component process of the RSADCM software engineering process, comprising the creation of a software design product based on the software architecture product.

“Development” is a component process of the R&D product or service creation process, comprising the use of data and information gathered during the research component process in the actual creation of said product or service.

“Development Environment” is a computing environment within which a hardware or software product is developed.

“Dynamic Code Generation” is a process by which source code is generated during the process of execution.

“Dynamic Hardware Reconfiguration” is a method of parallelization comprising the run-time modification of the physical hardware of a parallel computing platform such as an FPGA processor.

“Eclipse” is a software IDE, comprising a GUI written in the Java programming language, providing support for source code written in multiple programming languages.

“Environment” is one or more surrounding conditions within which a phenomena exists.

“Execution” is a process by which one or more instructions is carried out by one or more pieces of computer hardware or software.

“Field-Programmable Gate Array” or “FPGA” is a class of reconfigurable microprocessors, comprising a silicon or other semiconductor substrate created via standard microprocessor production procedures.

“Fortran” is an imperative programming language standard designed for standard serial computing platforms.

“Function” is a unit of source code, comprising a representation of the mathematical concept of one or more operations applied to one or more optional input data objects.

“Functional” is a class of programming languages, comprising data structures and algorithms designed with the function as the primary source code building block.

“Globus” is a grid software platform produced by an Internet development community.

“GNU's Not Unix” or “GNU” is a group of system software utilities produced by an Internet development community.

“GNU/Linux” is a class of operating systems, comprising a combination of the GNU utilities and the Linux kernel. All GNU/Linux operating systems are members of the *NIX class of operating systems.

“Google Android” is an operating system, comprising a combination of a GNU/Linux operating system and special software developed for mobile computing platforms.

“Graphical User Interface” or “GUI” is a user interface, comprising an interactive display of graphical images or animations.

“Grid Computer” or “Grid” is a hardware computing platform, comprising a combination of gridware and parallel system of multiple loosely-coupled computer systems located in multiple physical areas.

“Grid Computer Software”, “Gridware” or “Grid Middleware” is a class of software platforms, providing functionality of allowing computer systems located in multiple physical areas to be utilized as if said computer systems were located in a single physical area.

“Heterogeneity” is the ability for software to operate upon a plurality of different computing platforms.

“High Performance Computing” or “HPC” is the application of parallel computing practices to a problem set in order to speed up application execution time or to be able to handle more data.

“Homogenize” is an operation that accepts as input a list of lists, and increases the size of each list to match the size of the longest list.

“imperative” is a type of programming language based on a sequence of instructions and a mutable state.

“Implicit & Explicit Parallelization” are parallelization methods based on the implied nature of an algorithm or data structure, or the explicitly described directions of a software developer.

“Information” is a component of the DIKW logical hierarchy, comprising organized and meaningful data.

“Instraction” is a process by which data or a data type is converted from a generic form to a more specific form. For example, a generic “integer” data type of a translational programming language may be converted to a corresponding specific “integer” data type of the programming language Perl via the process of instraction. Contrast with abstraction.

“Interface” is the overlap of two or more phenomena.

“Knowledge” is a component of the DIKW logical hierarchy, comprising a collection of analyzed and understood information.

“Logical Hierarchy” is a multiple level organization derived from the logical relationships between its constituent units.

“Manual Parallelization” is a process by which software is made to execute concurrently upon a parallel computing platform, requiring significant parallel detail specification by the software developer. This process should result in a difficulty of parallel software development. Contrast with automatic parallelization.

“Maintenance” is a component process of the RSADCM software engineering process, comprising the creation of documentation, fixing bugs, and providing support for software source code product.

“Message Passing” is a parallelization platform based on the interchange of data communications between concurrent processes.

“Message Passing Interface” or “MPI” is a collection of application programming interfaces and message passing primitives used to create parallel programs.

“Meta-Arguments” are arguments to a software operation or data object meant to alter the normal arguments or behavior of said operation or data type.

“Meta-Operating System” or “Meta-OS” is computer software providing an abstracted model of an operating system, and designed to control one or more underlying operating systems. A meta-operating system comprises systems software providing similar functionality to an operating system with the additional functionality of controlling other operating systems rather than controlling only a single computing platform.

“Meta-Programming” is a method of programming in a target object programming language by way of a origin meta-language.

“Meta-Object” or “Monad” is a CPML with behavior similar to an object.

“Multi-Dimensional Operations” are operations that accept lists or lists of lists as input arguments.

“Native Application” is application software designed to naturally operate within a meta-operating system on a parallel computing platform.

“Native Application Cross-Linking” is a means of communicating between native applications and non-native applications.

“Native Operating System” is operating system software designed to naturally operate within a meta-operating system on a parallel computing platform.

“Non-Native Application Support” is one or more means of utilizing application software that is not native to a meta-operating system within said meta-operating system.

“Object-Oriented” is a type of computer programming language based on logical hierarchies of CMPLs, objects, data members, and methods.

“Parallel Computing Platform” is a combination of computing hardware and software allowing for the execution of a plurality of concurrent processes.

“Parallelization” refers to the process of turning a sequentially ordered set of programmatic operations into a set of smaller operations that can be executed substantially, independent of one another for the purposes of speeding up the overall computation.

“Parallelization Platform” is a means of parallelization of computer software.

“Parallel Virtual Machine” or “PVM” is a programming environment developed at Oak Ridge National Laboratories that supports a series of message passing and process management operations.

“Polymorphism” is a means of computer software altering its own structure or functionality.

“Portability” is the ability of computer software to be moved from its origin development computing platform to another computing platform with little to no modification.

“Porting” is a means of recreating computer hardware or software to execute within an environment different from that within which is was originally designed.

“Pure Functionality” is a property of functional programming languages entailing a complete absence of side-effects or statefulness.

“Quantum Fluctuation” or “QFlux” is a logical hierarchy representing the nature of existence in this universe, comprising the naturally occurring motion of quantum particles, waves, and energies.

“Reflect Diagonal” is an operation comprising the reflection of a list of lists along the matrix diagonal.

“Representational Calculus” is a type of programming language used to represent logical operations and relationships between algorithms and data objects.

“Requirements” are a component product of the RSADCM software engineering process, comprising a formalized description of the needs and expectations of the intended user base audience or system setting of the software product under development.

“Requirements Gathering” is a component process of the RSADCM software engineering process, comprising the creation of a software requirements product.

“Requirements, Specifications, Architecture, Design, Code, Maintenance” or “RSADCM” is a software engineering process comprising six component processes, with the goal of starting with a concept and ending with a fully functional software product. This process is often used interchangeably with the term software development.

“Set/Matrix/Array/List/Vector/Sequence” or “SMALVS” is a data type comprising one or more data types in a list format.

“SIMD, MISD, MIMD” are instruction and data configurations meaning single-instruction-multiple-data, multiple-instruction-single-data, and multiple-instruction-multiple-data, respectively.

“Software As A Service” or “SAAS” is the use of a client/server software architecture to deliver software functionality as a service to a possibly remote user.

“Source Code” or “Code” is a component product of the RSADCM software engineering process, comprising a machine-executable implementation of the software product under development. One or more programming languages are used during creation of the source code product.

“Specifications” are a component product of the RSADCM software engineering process, comprising a formalized description of the intended behavior of the software product under development.

“Specifications Drafting” is a component process of the RSADCM software engineering process, comprising the creation of a software specifications product based on the software requirements product.

“Subdivide” is an operation comprising the splitting up of another operation's argument of a list of lists into copies of said other argument with individual sub-lists of said argument of lists of lists.

“Symmetric Multi-Processing” is a parallel hardware platform comprising a plurality of processing units within a single computing unit.

“System Software” is a software product designed to be primarily utilized as a background process or by other software products. Contrast with application software.

“Threading” is a method of parallelization including the sharing of memory between multiple concurrent processes.

“Translational” is a type of programming language used for translating between other programming languages.

“Universal Language Representation” is the ability to represent any component from any programming language.

“User Interface” is the interactive bridge between a computing system and one or more of its user.

“Virtual Reality” is a user interface comprising high-definition 3-dimensional images and optional tactile feedback mechanisms.

“Web 2.0” is the next generation of web-based applications providing a high level of interactivity comparable to that found with locally executing applications.

“Wisdom” is a component of the DIKW logical hierarchy, comprising an ability to take appropriate action based on knowledge.

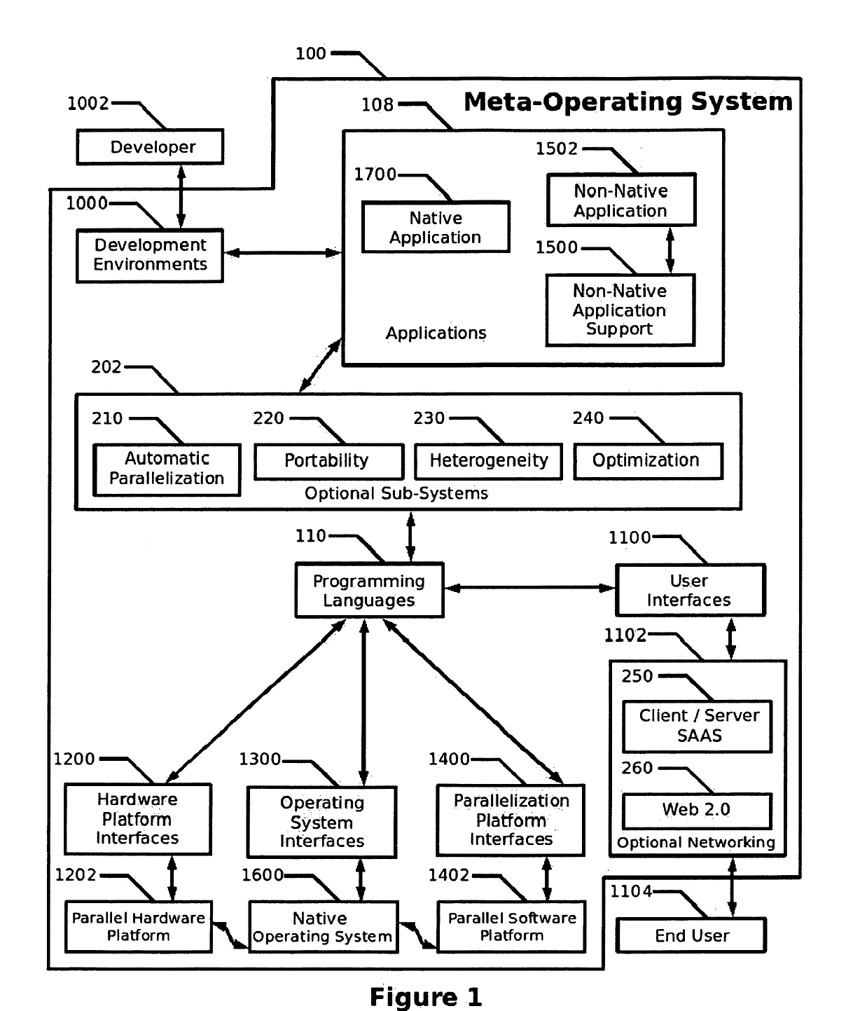

Turning now to the drawings, FIG. 1 is a diagrammatic illustration of an exemplary embodiment of a meta-operating system 100 of the present disclosure. A software developer 1002 utilizes a software development environment 1000 to create application software 108, comprising one or more of either native applications 1700 to the meta-operating system 100 or non-native applications 1502 by way of non-native application support 1500 components. Non-native application support 1500 may comprise one or more of source code translation 1510 (from ex. C/C++, Fortran, Java, Perl), native application cross-linking 1520, computational kernel porting 1530, or others. Application software 108 may be operated upon by optional sub-systems 202, possibly including automatic parallelization 210, platform portability 220, platform heterogeneity 230, performance optimization 240, or others. Possibly altered application software 108 is passed to computer programming language 110 components. Programming language 110 input and output is passed between interface components 104. Hardware platform interfaces 1200 operate upon parallel hardware platforms 1202, which in turn communicate with native operating systems 1600. Operating system interfaces 1300 operate upon native operating systems 1600, which in turn communicate with parallel software platforms 1402. Parallelization platform interfaces 1400 operate upon parallel software platforms 1402. User interfaces 1100 may utilize optional networking 1102, comprising one or more of client/server SAAS 250, Web 2.0 260, or others. Possibly altered user interfaces 1100 communicate with end user 1104.

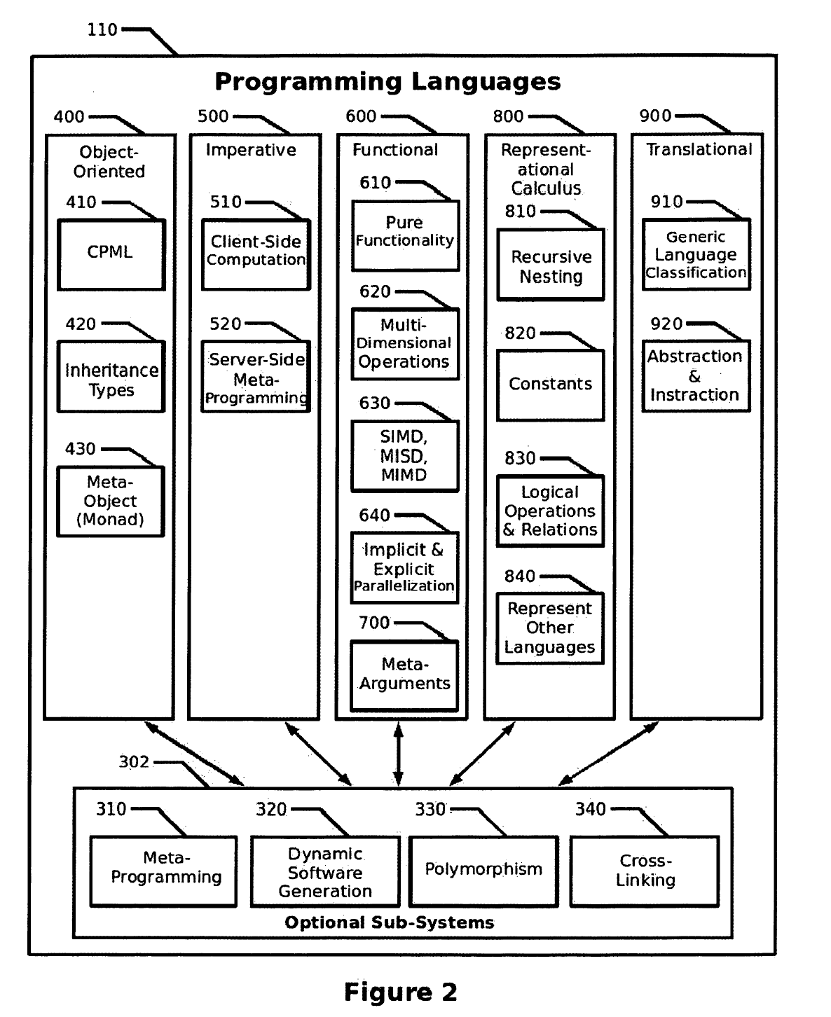

FIG. 2 is a diagrammatic illustration of an exemplary embodiment of the computer programming languages 110 of the present disclosure. Programming languages 110 comprise one or more of object-oriented 400, imperative 500, functional 600, representational calculus 800, translational 900, or others. Programming languages 110 may utilize optional sub-systems 302, comprising one or more of meta-programming 310, dynamic software generation 320, polymorphism 330, cross-linking 340, or others. Object-oriented 400 programming languages 110 may comprise one or more of CPMLs 410, multiple inheritance types 420, meta-objects 430, or others. Imperative 500 programming languages 110 may comprise one or more of client-side computation 510, server-side meta-programming 520, or others. Functional 600 programming languages 110 may comprise one or more of pure functionality 610, multi-dimensional operations 620, SIMD/MISD/MIMD 630, implicit/explicit parallelization 640, meta-arguments 700, or others. Meta-arguments 700 may comprise one or more operations of homoginize 710, reflect diagonal 720, subdivide 730, clean singleton brackets 740, no operation 750, parallelize 760, or others. Representational calculus 800 programming languages 110 may comprise one or more of recursive nesting 810, constants 820, logical operations/relations 830, representation of other languages 840, or others. Translational 900 programming languages 110 may comprise one or more of generic language classification 910, abstraction/instraction processes 920, or others.

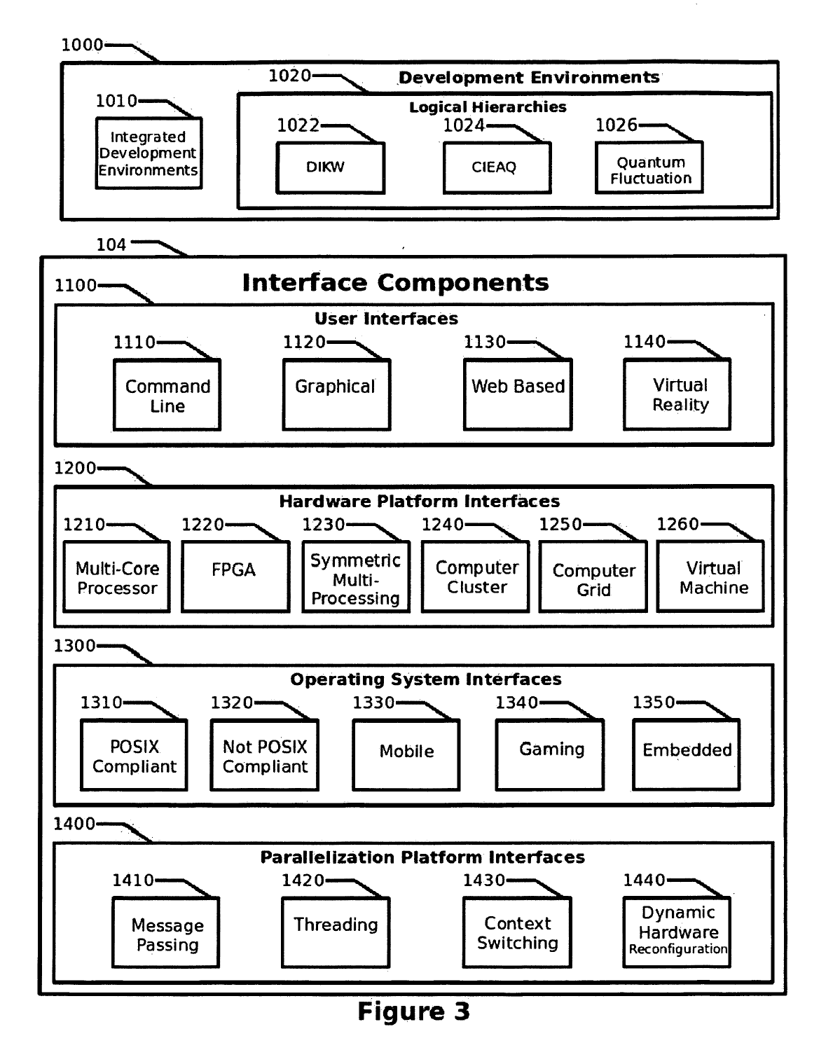

FIG. 3 is a diagrammatic illustration of an exemplary embodiment of the development environments 1000 and interface components 104 of the present disclosure. The development environments 1000 may comprise one or more of integrated development environments 1010 (ex. Eclipse, Microsoft Visual Studio, Visual SlickEdit), logical hierarchies 1020, or others. The logical hierarchies 1020 may comprise one or more of DIKW 1022, CIEAQ 1024, Quantum Fluctuation 1026, or others. The interface components 104 may comprise one or more of user interfaces 1100, hardware platform interfaces 1200, operating system interfaces 1300, parallelization software platform interfaces 1400, or others. The user interfaces 1100 may comprise one or more of command line 1110, graphical 1120, web-based 1130, virtual reality 1140, or others. The hardware platform interfaces 1200 may comprise one or more of multi-core processors 1210 (ex. AMD, Intel, Cell/BE, GPU), FPGAs 1220 (ex. Starbridge Hypercomputer, Cray XT5, SGI RASC), symmetric multi-processing 1230, computer clusters 1240 (ex. ROCKS, Puppy, Microsoft Windows Compute Cluster Server), computer grids 1250 (ex. Globus, Sun GridEngine), virtual machines 1260 (ex. VMware, Xen, KVM, Bootcamp), or others. The operating system interfaces 1300 may comprise one or more of POSIX-compliant 1310 (ex. GNU/Linux, BSD, Apple Macintosh, Sun Solaris), not POSIX-compliant 1320 (ex. Microsoft Windows), mobile 1330 (ex. Google Android), gaming 1340 (ex. Nintendo Wii, Sony Playstation, Microsoft X-Box), embedded 1350, or others. The parallelization platform interfaces 1400 may comprise one or more of message passing 1410 (ex. MP11, MP12, PVM), threading 1420 (ex. PThreads, Cray Threads), context switching 1430 (IBM Cell/BE SDK, Mercury Computer MultiCore Plus SDK), dynamic hardware reconfiguration 1440 (ex. Starbridge Viva, Celoxica Handel-C, Nallatech DIME-C, Mitrionics Mitrion-C, Impulse Accelerated Technologies Impulse-C), or others.

In addition to the foregoing embodiments, the present disclosure describes programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

For example, the present disclosure contemplates a tangible medium storing computer readable software for managing one or more computer operating systems or applications executing upon one or more parallel computing platforms, said executed software providing a meta-operating system. The software male include, but not be limited to, the following elements and functionalities: (i) one or more computer programming languages providing flexible development of native applications to execute upon said parallel computing platforms; (ii) one or more development environments providing ease of development of native applications to execute upon said parallel computing platforms; (iii) one or more user interfaces providing a means of human-accessible control over said method; (iv) one or more hardware platform interfaces providing a means of executing said method upon one or more specific parallel computing hardware platforms; (v) one or more operating system interfaces providing a means of executing said method upon one or more specific operating systems; (vi) one or more parallelization platform interfaces providing a means of executing said method upon one or more specific software parallelization platforms; and (vii) one or more systems of non-native application support providing a means of executing non-native applications through said method.

Accordingly, many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A tangible medium storing computer readable software for managing one or more computer operating systems or applications executing upon one or more parallel computing platforms, said executed software providing a meta-operating system, and comprising one or more of:
(i) one or more computer programming languages providing flexible development of native applications to execute upon said parallel computing platforms;
(ii) one or more development environments providing ease of development of native applications to execute upon said parallel computing platforms;
(iii) one or more user interfaces providing a means of human-accessible control over said method;
(iv) one or more hardware platform interfaces providing a means of executing said method upon one or more specific parallel computing hardware platforms;
(v) one or more operating system interfaces providing a means of executing said method upon one or more specific operating systems;
(vi) one or more parallelization platform interfaces providing a means of executing said method upon one or more specific software parallelization platforms; and
(vii) one or more systems of non-native application support providing a means of executing non-native applications through said method.

2. The tangible medium storing computer readable software of claim 1, further comprising one or more of:
(i) one or more means of automatic parallelization of native applications non-native applications or system software:
(ii) one or more means of portability of native applications non-native applications or system software between a plurality of parallel computing platforms:
(iii) one or more means of executing native applications non-native applications or system software upon a plurality of heterogeneous parallel computing platforms;
(iv) one or more means of optimization providing increased execution performance of native applications non-native applications or system software upon one or more serial or parallel computing platforms;
(v) one or more means for a client/server or software to provide an architecture for both local and remote access to meta-operating system functionality; and
(vi) Web 2.0 functionality providing interactive or advanced remote access to meta-operating system functionality.

3. The computer programming languages of claim 1, further comprising one or more of:
(i) one or more means for meta-programming providing the run-time or compile-time manipulation of native applications non-native applications or system software other than that which is performing the meta-programming;
(ii) one or more means for dynamic software generation providing the run-time or compile-time creation of native applications non-native applications or system software other than that which is performing the dynamic software generation;
(iii) one or more means for software polymorphism providing the run-time or compile-time manipulation of the native applications non-native applications or system software which is performing the software polymorphism; and
(iv) one or more means for software to provide the run-time or compile-time manipulation of the native applications non-native applications or system software which is performing the software polymorphism.

4. The computer programming languages of claim 1, further comprising an object-oriented programming language and one or more of:
(i) one or more software organization units, comprising a class, package, module or library providing a structured source code template for general purpose software development;
(ii) one or more software inheritance types comprising inheritable CPML lineage being, non-inheritable CPML individual being or non-inheritable object lineage being, providing a structured source code logical hierarchy for general purpose software development; and
(iii) one or more meta-objects, comprising a monad/highlander class or translucent meta-state, providing a means for structured data storage or sharing for general purpose software development.

5. The computer programming languages of claim 1, further comprising an imperative programming language and one or more of:
(i) one or more means for client-side computation comprising software capable of execution on a client user's computing platform providing a remote execution structure for general purpose software development; and
(ii) one or more means for server-side meta-programming comprising software capable of creating other software for execution on a client user's computing platform providing a remote execution structure for general purpose software development.

6. The computer programming languages of claim 1, further comprising a functional programming language and one or more of:
(i) pure functionality comprising software components that do not utilize variables or other representations of state to provide a structure free of side-effects for general purpose software development;
(ii) one or more means for utilizing meta-arguments comprising software argument components that modify themselves or other argument components to provide a structure of meta-programming and polymorphism for general purpose software development;
(iii) one or more means for utilizing multi-dimensional operations comprising software operation components that accept argument data of arbitrary dimensional nesting, providing a structure of parallelizable operations for general purpose software development;
(iv) one or more means for utilizing single-instruction-multiple-data, multiple-instruction-single-data or multiple-instruction-multiple-data software components comprising software operation components that combine a plurality of operations and data objects to provide a structure of parallelizable operations for general purpose software development; and
(v) one or more means for utilizing both implicit and explicit parallelization comprising software algorithm and data structure components that may be parallelized due to either the implied nature of said component or the software developer's explicitly described patterns provide a structure of parallelizable operations for general purpose software development.

7. The meta-arguments of claim 6, further comprising one or more of:
(i) one or more meta-arguments representing the homogenize operation comprising a numeric value or software statement resolving to a numeric value, providing a number of times to cause all argument components of particular operation components to become a single common length;
(ii) one or more meta-arguments representing the reflect diagonal operation comprising a numeric value or software statement resolving to a numeric value, providing a number of times to reflect argument components of particular operation components along said argument's matrix diagonal;
(iii) one or more meta-arguments representing the subdivide operation comprising a numeric value or software statement resolving to a numeric value, providing a number of times to subdivide argument components of particular operation components into sub-arguments passed to replicated copies of said operation components;
(iv) one or more meta-arguments representing the clean singleton brackets operation comprising a numeric value or software statement resolving to a numeric value, providing a number of times to remove possibly extraneous dimensional nesting levels of argument components of length l of particular operation components;
(v) one or more meta-arguments representing the null operation comprising a numeric value or software statement resolving to a numeric value, providing a number of times to return argument components of particular operation components without actually performing said operation component; and
(vi) one or more meta-arguments representing the parallelize operation comprising a numeric value or software statement resolving to a numeric value, providing a number of times to execute particular operation components upon available parallel computing platforms.

8. The computer programming languages of claim 1, further comprising a representational calculus programming language and one or more of:
(i) one or more means for software component recursive nesting comprising software components that are organized in particular logical hierarchies by way of arbitrarily deep combinations of dimensional nesting, providing a knowledge representation structure for general purpose software development;
(ii) one or more means for representing constant software components comprising software components that contain immutable values or statements, providing a knowledge representation structure for general purpose software development;
(iii) one or more means for representing logical operation and relation software components comprising software components that are organized by way of logical software operations and the relationships between one another, providing a knowledge representation structure for general purpose software development; and
(iv) one or more means for representing other programming language's software components comprising software components that represent one or more respective software components in another computer programming language, providing a structure of meta-programming for general purpose software development.

9. The computer programming languages of claim 1, further comprising a translational programming language and one or more of:
(i) one or more means for generic language classification comprising software components that are representative of all instances of a particular language component type across a group of programming languages, providing a universal language representation structure for general purpose software development; and
(ii) one or more means for software component abstraction and instraction comprising upward conversion of origin programming language components to generic language classification components and downward conversion of generic language classification components to destination programming language components, providing a universal language translation structure for general purpose software development.

10. The development environments of claim 1, further comprising one or more of:
(i) one or more integrated development environments comprising software components that interface with source code editors and software development utilities to provide ease of development of native applications and
(ii) one or more logical hierarchies comprising structured design, architecture and source code templates to provide ease of development of native applications.

11. The user interfaces of claim 1, further comprising one or more of:
(i) one or more command line interfaces comprising software components that generate an interactive text stream of user input and computed output to provide a means for human-accessible meta-operating system control;
(ii) one or more graphical interfaces comprising software components that generate an interactive 2-dimensional image stream of user input and computed output to provide means for human-accessible meta-operating system control;
(iii) one or more web interfaces comprising software components that generate an interactive remote access stream of user input and computed output to provide a means for human-accessible meta-operating system control; and
(iv) one or more virtual reality interfaces comprising software components that generate an interactive 3-dimensional image stream of user input and computed output to provide a means for human-accessible meta-operating system control.

12. The hardware platform interfaces of claim 1, further comprising one or more of:
(i) one or more multi-core processor interfaces comprising software components that generate operations targeted to a plurality of processor cores located within a single processing unit to provide a means for parallel execution of native applications non-native applications or system software;
(ii) one or more field-programmable gate array interfaces comprising software components that generate operations targeted to a plurality of dynamically reconfigurable processor cores located within a single processing unit to provide a means for parallel execution of native applications non-native applications or system software;
(iii) one or more symmetric multi-processing interfaces comprising software components that generate operations targeted to a plurality of processing units located within a single computing unit to provide a means of parallel execution of native applications non-native applications or system software;
(iv) one or more computer cluster interfaces comprising software components that generate operations targeted to a plurality of computing units located within a single physical proximity to provide a means for parallel execution of native applications non-native applications or system software;
(v) one or more computer grid interfaces comprising software components that generate operations targeted to a plurality of computing units located within a plurality of physical proximities to provide a means for parallel execution of native applications non-native applications or system software; and
(vi) one or more virtual machine interfaces comprising software components that generate operations targeted to a one or more virtual processors located within one or more virtual computing units to provide a means for parallel execution of native applications non-native applications or system software.

13. The operating system interfaces of claim 1, further comprising one or more of:
(i) one or more POSIX interfaces comprising software components that generate operations targeted to a POSIX-compliant operating system to provide a means for parallel execution of native applications non-native applications or system software;
(ii) one or more non-POSIX interfaces comprising software components that generate operations targeted to a non-POSIX-compliant operating system to provide a means for parallel execution of native applications non-native applications or system software;
(iii) one or more mobile interfaces comprising software components that generate operations targeted to a mobile device operating system to provide a means for parallel execution of native applications non-native applications or system software;
(iv) one or more gaming interfaces comprising software components that generate operations targeted to a gaming operating system to provide a means for parallel execution of native applications non-native applications or system software; and
(v) one or more embedded interfaces comprising software components that generate operations targeted to an embedded operating system to provide a means for parallel execution of native applications non-native applications or system software.

14. The parallelization platform interfaces of claim 1, further comprising one or more of:
(i) one or more message passing interfaces comprising software components that generate operations targeted to a message passing parallelization software platform to provide a means for parallel execution of native applications non-native applications or system software;
(ii) one or more threading interfaces comprising software components that generate operations targeted to a threading parallelization software platform to provide a means of parallel execution of native applications non-native applications or system software;
(iii) one or more context stitching interfaces comprising software components that generate operations targeted to a context switching parallelization software platform to provide a means for parallel execution of native applications non-native applications or system software; and
(iv) one or more dynamic hardware reconfiguration interfaces comprising software components that generate operations targeted to a dynamic hardware reconfiguration parallelization software platform to provide a means of parallel execution of native applications non-native applications or system software.

15. The non-native application support of claim 1, further comprising one or more of:
(i) one or more methods of source code translation comprising methods that convert the source code of a non-native application from one or more origin programming languages to one or more meta-operating system destination programming languages to provide a means for executing non-native applications through the meta-operating system;
(ii) one or more methods of native application cross-linking comprising methods of compile-time or run-time interfaces between non-native applications and native applications to provide a means for executing non-native applications through the meta-operating system; and
(iii) one or more methods of computational kernel porting comprising methods of re-programming one or more computationally intensive portions of non-native applications into one or more respective native applications to provide a means of executing non-native applications through the meta-operating system.

16. A native operating system comprising operating system executable software installed on a parallel computing platform having a tangible medium for storing and executing computer readable software, the operating system utilizing one or more operating system interfaces and providing an operating system capable of executing native applications upon one or more parallel computing platforms.

17. A method for computing one or more algorithms and data structures with a parallel computing platform having a tangible medium for storing and executing computer readable software, said method comprising the steps of providing to a parallel computing platform an application meta-operating system utilizing one or more programming languages and providing one or more algorithms and data structures capable of executing upon one or more parallel computing platforms.
